(19) United States
(12) Patent Application Publication
(10) Pub. No.: US 2024/0073384 A1
(43) Pub. Date: Feb. 29, 2024

(54) CONTRAST ENHANCEMENT VIA TIME-SEQUENTIAL PROJECTION OF SCENE CONTENT

(71) Applicant: TEXAS INSTRUMENTS INCORPORATED, Dallas, TX (US)

(72) Inventors: Muralidhar MADABHUSHI BALAJI, Dallas, TX (US); Terry Alan BARTLETT, Dallas, TX (US); Jeffrey Matthew KEMPF, Dallas, TX (US); James Norman HALL, Parker, TX (US)

(21) Appl. No.: 17/895,888

(22) Filed: Aug. 25, 2022

(51) Int. Cl. H04N 9/31; G02B 27/01

(52) U.S. Cl. CPC H04N 9/3179; G02B 27/0103; H04N 9/3164

(57) ABSTRACT

A device includes at least one processor configured to partition a source image including image components into sub-images, each including a corresponding image component of the image components, and process each sub-image to produce a target image to be projected for each sub-image of the sub-images. The device also includes one or more light sources coupled to the at least one processor and configured to project an incident light, and a phase projection-based display device coupled to the at least one processor and optically coupled to the one or more light sources and configured to modulate, based on the target image of each sub-image, the incident light to separately project the sub-images.

### BACKGROUND

Projection-based displays project images onto projection surfaces, such as onto a wall or a screen, to display video or still pictures for viewing. Such displays can include cathode-ray tube (CRT) displays, liquid crystal displays (LCDs), and spatial light modulator (SLM) displays, etc. For examples, SLMs can be useful in heads up displays (HUD), cinema, televisions, presentation projectors, near eye display, automotive console displays, light field displays, and high dynamic range projectors.

### SUMMARY

In accordance with at least one example of the disclosure, a device includes at least one processor configured to partition a source image including image components into sub-images, each including a corresponding image component of the image components, and process each sub-image to produce a target image to be projected for each sub-image of the sub-images. The device also includes one or more light sources coupled to the at least one processor and configured to project an incident light, and a phase projection-based display device coupled to the at least one processor and optically coupled to the one or more light sources and configured to modulate, based on the target image of each sub-image, the incident light to separately project the sub-images.

In accordance with at least one example of the disclosure, a vehicle includes a projector device mounted in the vehicle and comprising at least one processor configured to partition a source image including image components into multiple sub-images, each including a corresponding mage component of the image components, and process each sub-image to produce a target image to be projected for each sub-image. The projector device also includes one or more light sources coupled to the at least one processor and configured to project an incident light, and a phase projection-based display device coupled to the at least one processor and optically coupled to the one or more light sources and configured to modulate, based on the target image of each sub-image, the incident light to separately project the sub-images, where the phase projection-based display device is configured to project the sub-images on a projection surface on a front windshield of the vehicle.

In accordance with at least one example of the disclosure, a method includes obtaining, by a processor, a source image including image components, and partitioning, by the processor, the source image including image components into multiple sub-images, where each sub-image of the sub-images has a same size as the source image, and each sub-image includes a different image component of the image components from the source image. The method also includes processing each sub-image to produce a target image to be projected for each sub-image, and sequentially modulating, by a phase projection-based display device and based on the target image of each sub-image, incident light from one or more light sources to project each sub-image separately and produce a far-field image for each target image.

### BRIEF DESCRIPTION OF THE DRAWINGS

FIG. 1 is a diagram of a display system, in accordance with various examples.

FIG. 2 is a diagram of a HUD system, in accordance with various examples.

FIG. 3 is a diagram of an apparatus of a phase light modulator (PLM) display device, in accordance with various examples.

FIG. 4A shows projected images by the apparatus of FIG. 3, in accordance with various examples.

FIG. 4B shows projected images by the apparatus of FIG. 3, in accordance with various examples.

FIG. 5 is a diagram of an apparatus of a liquid crystal display (LCD) device, in accordance with various examples.

FIG. 6 shows a displayed image of a heads-up display (HUD), in accordance with various examples.

FIG. 7A shows a source image with a single image component, in accordance with various examples.

FIG. 7B shows a displayed image obtained by projecting the source image of FIG. 7A, in accordance with various examples.

FIG. 7C is a diagram representing contrast variation in the displayed image of FIG. 7B, in accordance with various examples.

FIG. 8 shows a source image including multiple image components, in accordance with various examples.

FIG. 9A shows a displayed image obtained by projecting the source image of FIG. 8, in accordance with various examples.

FIG. 9B shows a displayed image obtained by projecting sub-images of the source image of FIG. 8 according to a time-sequential projection of sub-images of the source image, in accordance with various examples.

FIG. 10A is a graph representing contrast in displayed images obtained by processing source images with different average picture levels (APLs) and fifty iterations of a Gerchberg and Saxton (GS) algorithm, in accordance with various examples.

FIG. 10B is a graph representing contrast in displayed images obtained by processing source images with different APLs and five iterations of the GS algorithm, in accordance with various examples.

FIG. 11A shows a displayed image obtained by projecting the source image of FIG. 8 with zero-order light illumination, in accordance with various examples.

FIG. 11B shows a displayed image obtained by projecting the source image of FIG. 8 with zero-order light illumination and with high gain light intensity, in accordance with various examples.

FIG. 11C shows a displayed image obtained by projecting the source image of FIG. 8 according to a time-sequential projection of sub-images of the source image and with zero-order light illumination, in accordance with various examples.

FIG. 11D shows a displayed image obtained by projecting the source image of FIG. 8 according to a time-sequential projection of sub-images of the source image with zero-order light illumination and high gain light intensity, in accordance with various examples.

FIG. 12 is a flow diagram of a method for time-sequential projection of an image, in accordance with various examples.

### DETAILED DESCRIPTION

Projection-based displays can include SLMs, which display projected images by changing the intensity of projected light across the displayed image pixels. For example, SLM displays include micro-electromechanical system (MEMS) based SLMs, such as digital mirror devices (DMDs). SLM displays also include liquid crystal-based SLMs, such as LCDs and liquid crystal on silicon (LCoS) devices. An SLM modulates the intensity of the projected light by controlling optical elements to manipulate the light and accordingly form the pixels of a displayed image. For example, in the case of a DMD, the optical elements are adjustable tilting micromirrors that are tilted by applying voltage. In the case of liquid crystal-based SLMs, the optical elements are liquid crystals that are controlled by voltage to modulate the intensity of the light across the image pixels.

The display system can also be based on one of various display methods. For example, according to a time multiplexing method of light projection, light for different color modes (e.g., blue, green, and red) is emitted in sequence in time by respective light sources, such as lasers or light emitting diodes (LEDs). The color modes can be projected by time multiplexing the respective light sources to display an image in full color. The sequence of switching the light sources for the respective color modes is set at a rate sufficiently high to allow the human eye to integrate a sequence of projected colored modes of the image into a single colored image.

Projection-based displays can also include PLMs for projecting images. A PLM can be a MEMS device including micromirrors that have adjustable heights with respect to the PLM surface. The heights of the micromirrors can be adjusted by applying voltages. The micromirrors may be controlled with different voltages to form a diffraction surface on the PLM. A controller can control, by applying voltage, the micromirrors individually to form the diffraction surface. For example, each micromirror can be coupled to respective electrodes for applying a voltage and controlling the micromirror independently from the other micromirrors of the PLM. The diffraction surface is a phase altering reflective surface to light incident from light sources. The phase altering reflective surface represents a hologram, also referred to herein as a phase hologram, for projecting illumination patterns of light that form an image on an image projection surface. The hologram is formed as a diffraction surface by adjusting the heights of the micromirrors of the PLM. The heights of the micromirrors may be adjusted to form a certain hologram by controlling the voltages applied to each micromirror. The hologram is formed based on a source image that is to be displayed by projecting the light on the projection surface.

An image can be projected by the PLM to a certain distance, also referred to herein as a far field. The far field can be located on a projection surface, such as a screen, which represents a far field imaging plane of the image. When the PLM is illuminated by an incident light, the light is modulated by the hologram formed at the surface of the PLM and projected towards the far field, causing an image to appear on the projection surface, which is also referred to herein as a far-field image. The incident light is composed of light waves having a phase which is altered by the hologram, producing the modulated light that is projected towards the far field. The brightness of the image varies across the image because of constructive and destructive interference of the light waves at the far field on the projection surface. The projection of the modulated light from the PLM to the projection surface, or the far field imaging plane, can be represented mathematically by a Fourier transform from a source plane located at the surface of the PLM to a far field imaging plane located at the projection surface. The Fourier transform is a mathematical function that transforms the hologram at the source plane to the far-field image at the far field imaging plane. The Fourier transform can transform a first mathematical value representing the hologram with certain phase and amplitude values into a second mathematical value representing the far field image with transformed phase and amplitude values.

The controller can switch each of the PLM micromirrors between multiple discrete and different heights to form the hologram that modulates the reflected incident light from the light sources. This switching of the PLM micromirrors can be at a speed that projects a sequence of images in time at a faster rate than other display devices such as LCOS displays. For example, the PLM can project a sequence of images in time at a rate of tens of kilohertz (kHz). If used as a phase-only light modulator, the PLM can also have a diffraction efficiency higher than a MEMS based SLM, such as a DMD. The DMD, having two stable states (e.g., on and off states), can be useful to create binary holograms if operated in a binary diffraction mode. In this mode, the DMD may have lower efficiency than a PLM. For example, the PLM can provide a diffraction efficiency of approximately 89 percent (%) in comparison to a diffraction efficiency of approximately 10% for the DMD if operated as a binary phase modulator. The diffraction efficiency of a display system is a measure of the amount (e.g., energy) of light projected onto an image relative to the amount of light provided by the light sources. The majority of the efficiency loss in direct imaging-based SLMs, such as liquid crystal-based SLMs and DMDs, is caused by blocking some of the light to form dark pixels or regions in the displayed image. In the case of PLMs, the dark pixels are produced by the destructive interference of light waves in the modulated light without blocking a portion of the light. PLM also projects a sequence of images in time at a faster rate than liquid crystal based SLMs, such as LCDs and LCoS devices that may project the sequence of images at rates within hundreds of hertz. The relatively faster projection rate of the PLM in comparison to liquid crystal-based SLMs allows the human visual system (HVS) to integrate more images displayed within a certain time to perceive single images. For example, the HVS can generally integrate 30 displayed image frames per second or less as a single perceived image.

Display systems including SLMs and PLMs can also add noise in the displayed image. The noise can cause a fluctuation or deviation in the correct color shades in regions of the displayed image. Phase-only light modulators can produce images with some noise content. The noise can be exacerbated by the quantization of the phase values in image processing. For example, modulating light by a PLM produces a quantization-induced noise in the displayed image because the fixed number and positions of the micromirrors on the PLM form a fixed number and position of pixels in the image. The quantization noise is caused by processing an analog signal representing the image as a digital signal representing the image pixels. The error caused by this approximation of the analog signal with the digital signal is referred to as quantization noise. The quantization noise may be a random error that causes random variation and hence error in the displayed brightness or color shades across the image pixels, which can reduce the difference between bright and dark pixels and regions of the image, also referred to herein as contrast. The noise can increase in the displayed image by the image processing algorithm implemented by the display system, such as to generate the PLM hologram for projecting the image. For example, the image processing algorithm can be an iterative algorithm that starts from a random or estimated initial phase image for the hologram value based on the image value, which can introduce initial noise. The hologram value is then updated over multiple iterations to reach or converge to a final hologram value that can be loaded onto the PLM. Increasing noise in the displayed image increases the error in brightness or color shades in the image pixels which reduces the ratio between maximum brightness and minimum brightness in the displayed image pixels, also referred to herein as contrast ratio.

This description includes examples for implementing a time-sequential projection by a PLM to reduce noise and increase contrast in the displayed image. The time-sequential projection includes partitioning an image to be displayed, also referred to herein as a source image, into a plurality of images, referred to herein as sub-images. The sub-images can include different image components of the source image. Accordingly, each sub-image can include a portion of the bright regions in the source image, and a remaining larger dark region which can be represented by more dark pixels. Each sub-image can then be processed separately and projected, such as by loading a hologram on the PLM. The processing/optimization algorithm (e.g., GS algorithm) to generate the hologram performs with higher accuracy when the source image has fewer on/bright pixels compared to dark pixels. Consequently, the processing/optimization algorithm can generate an optimized hologram that when loaded onto the PLM produces an image with noise being localized to the smaller bright region and surrounding areas. The sub-images are projected in sequence in time at a certain rate (e.g., hundreds of hertz to kHz) that is supported by the projection-based display device, such as the PLM, and that allows the HVS to integrate the images into a single combined image that represents the source image. This rate is referred to herein as the HVS image integration rate. The localization of the noise to the smaller bright regions in the sub-images reduces noise across the single combined image, increasing the contrast across the image as perceived by the HVS.

This time-sequential projection-based on partitioning the source image can be implemented in projection-based displays with optical elements, such as the PLM micromirrors, that can be switched at speeds which provide the HVS image integration rate. The projection-based displays can include liquid crystal-based displays with liquid crystals that have switching speeds capable of projecting images with rates within tens of kHZ. For example, ferroelectric liquid crystal on silicon (FLCoS) devices include ferroelectric liquid crystals (FLCs) that have a faster voltage response than other liquid crystal devices (e.g., LCoS and LCDs) and can project images at a rate above 1 kHz. Other examples of liquid crystal-based devices with switching speeds that allow the time sequential projection of sub-images to display a source image can include dual frequency liquid crystal (DFLC) devices, which contain liquid crystals with positive and negative dielectric anisotropy that have a response time within sub-milliseconds.

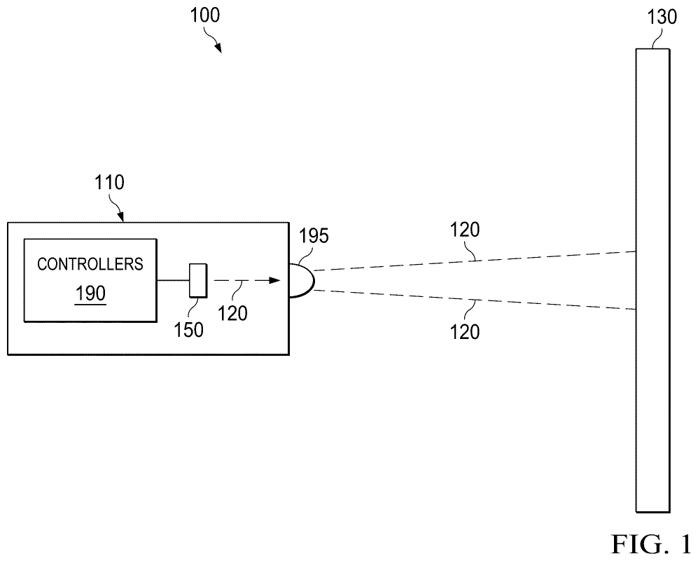

FIG. 1 is a diagram of a display system 100, in accordance with various examples. The display system 100 may be a projection-based display system for projecting images or video. The display system 100 includes a display device 110, which includes a phase projection-based display device 110 configured to project a modulated light 120 onto a projection surface 130 for viewing the image. Examples of the projection surface 130 include a wall or a viewing screen. For example, the viewing screen may be a wall screen, a screen of a HUD, an augmented reality (AR) or virtual reality (VR) display, a three-dimensional (3D) display screen, the ground or road for a headlight display, a projection surface in a vehicle such as for a windshield projection display, or other display surfaces for projection-based display systems. In examples, the display device 110 can be part of a wearable AR device, such as AR glasses or an AR HUD device. The wearable AR device can include two similar display devices 110 for projecting the same image, or related images, to be viewed by both eyes of a user in a near-eye display.

The modulated light 120 may be modulated by the display device 110 to project still images or moving images, such as video, onto the projection surface 130. The modulated light 120 may be formed as a combination of light with multiple color modes provided by the display device 110. The display device 110 includes an apparatus 150 for modulating and projecting the modulated light 120. The apparatus 150 can include one or more light sources (not shown) for providing light, also referred to herein as incident light, with different wavelengths for the color modes. The color modes can be projected simultaneously or by time multiplexing the respective light sources. In examples, the incident light at the different wavelengths is modulated and reflected by a phase projection-based display device such as a PLM (not shown) with micromirrors to produce the modulated light 120 for displaying images or video on the projection surface 130. In other examples, the apparatus 150 includes other phase projection-based display devices, such as FLCoS devices, with optical elements that can be switched at speeds equal to the PLM micromirrors and display images with rates up to tens of kHZ.

The display device 110 also includes one or more controllers 190 coupled to the apparatus 150 for controlling the components of the display device 110 to display the images or video. For example, the one or more controllers 190 can include a first controller (not shown) for controlling the PLM, or other light projection devices with equal switching speeds, to modulate the incident light of different wavelengths from the respective light sources. The one or more controllers 190 may also include a second controller (not shown) for controlling the light sources. The display device 110 may further include one or more input/output devices (not shown), such as an audio input/output device, a key input device, a display, and the like. The display device 110 can include a cover 195 through which the modulated light 120 is projected from the display device 110. The cover 195 is a transparent cover made of a dielectric material, such as glass or plastic, that transmits the modulated light 120 from the apparatus 150 to the projection surface 130. The cover 195 also protects the components of the display device 110 from outside elements.

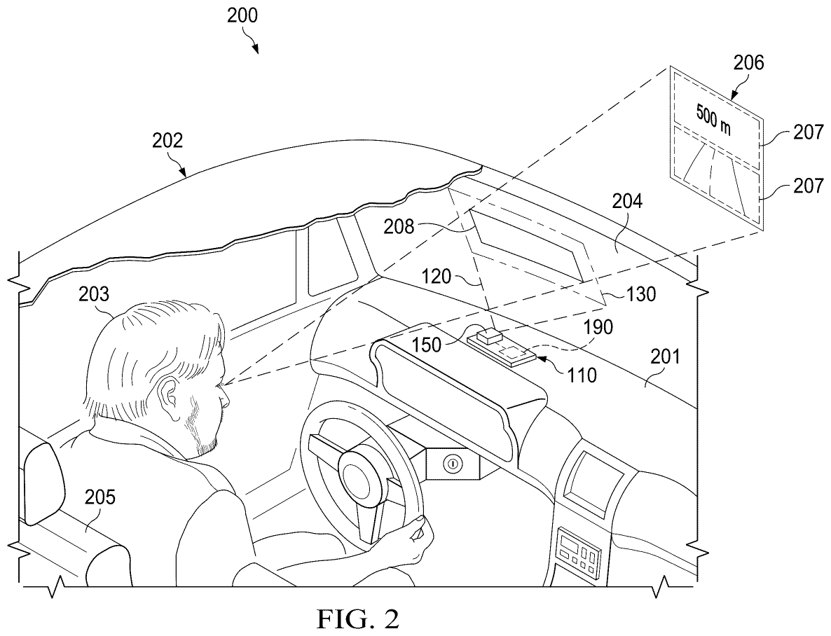

In examples, the display system 100 is a HUD system, where the projection surface 130 is a windshield in a vehicle. FIG. 2 is a diagram of a vehicle HUD system 200, in accordance with various examples. The vehicle HUD system 200 can be part of automobiles, aircrafts, of other driven machines. The vehicle HUD system 200 can be the display system 100 where the display device 110 may be a vehicle HUD projector embedded in or mounted inside a vehicle 202. The display device 110 can be embedded in or mounted on a dashboard 201 of a vehicle 202. The vehicle 202 can be operated or driven by a driver 203. In other examples, the display device 110 can be mounted or attached to a front windshield 204 or the interior roof of the vehicle 202. The display device 110 includes the controllers 190 and the apparatus 150 that projects the modulated light 120 onto the projection surface 130 which can be part of the front windshield 204. In examples, the display device 110 and the projection surface 130 can be positioned facing a driver seat 205 or at a center front position of the vehicle 202. The projection surface 130 is optically coupled to the display device 110 and is positioned on the front windshield 204 to allow the driver 203 to view the displayed images without blocking the view outside the front windshield 204 of the vehicle 202.

The vehicle HUD system 200 can be an AR HUD system that projects images 206 with image components 207, such as in the form of text, graphics, etc. The image components 207 indicate information useful to the driver 203 or a front passenger. For example, the components 207 of the image 206 can include a road trajectory line to guide the driver 203 on the road, route information and conditions (e.g., temperature, weather), gauges or text indicating vehicle information or conditions (e.g., speed, gas), messages, alerts, warnings, and the like. The displayed images 205 and image components 206 may not obstruct the view of the driver 203 and may not require the driver 202 to look, while driving, away from a line of sight in front of the vehicle 202. The projections surface 130 of the HUD system 200 can also include a holographic optical element (HOE) 208. The HOE 208 is an optical structure that can be manufactured on or in a glass material, such as the front windshield 204. For example, the HOE 208 can be a single layer of a diffraction grating or can be formed by multiple layers of diffraction gratings. The HOE 208 is a transparent diffraction surface that modulates light projected on the HOE 208 to produce 3D images that can be viewed looking though the projections surface 130. The modulated light 120 can be projected by the apparatus 150 of the display device 110 onto the HOE 208 of the projections surface 130 to display to the driver 203 the images 206 as 3D images. The 3D images can be perceived with a perception of depth in the direction of the line of sight in front of the vehicle 202.

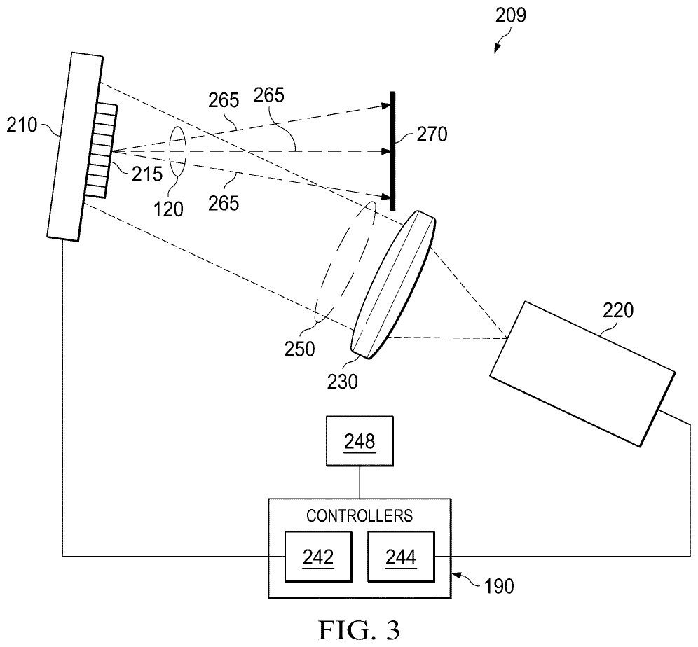

In examples, the apparatus 150 of the display device 110 in the display system 100 or the vehicle HUD system 200 includes a phase projection-based display device, such as a PLM or an FLCoS, that is optically coupled to one or more light sources. The phase projection-based display device is configured to modulate the phase of an incident light from the light sources to produce a modulated light for projecting images. FIG. 3 is a diagram of an apparatus 209 for projecting images, in accordance with various examples. For example, the apparatus 209 can be the apparatus 150 of the display device 110 and is coupled to the one or more controllers 190. The apparatus 209 includes a PLM 210 that includes micromirrors 215 on the surface, one or more light sources 220, and focusing optics 230 located between and optically coupled to the PLM 210 and the one or more light sources 220. The focusing optics 230 can include a single projection lens, as shown in FIG. 3, or can include multiple lenses in other examples. The PLM 210 and the one or more light sources 220 are coupled to and controlled by the one or more controllers 190.

In examples, as shown in FIG. 3, the one or more controllers 190 may include a first controller 242 for controlling the PLM 210 and a second controller 244 for controlling the one or more light sources 220. The controllers 190 may also include or may be coupled to a processor 248 configured to coordinate between the controllers 190 to control the PLM 210 and the one or more light sources 220, and accordingly modulate an incident light 250 transmitted from the one or more light sources 220. The controllers 190 can be coordinated by the processor 248 based on processing digital image data for source images. The first controller 242 may be an analog controller that can switch each of the micromirrors 215 of the PLM 210 between different heights. In other examples, the first controller 242 is a digital controller coupled to a static random access memory (SRAM) (not shown) including an array of memory cells each configured to store, in bits, voltage values to adjust respective micromirrors 215 of the PLM 210. The voltage values are useful to switch the micromirrors 215 to discrete heights. The second controller 244 can be a digital controller configured to switch the one or more light sources 220 on and off, or an analog controller that controls and changes the level of light intensity of the incident light 250 from the one or more light sources 220.

The micromirrors 215 of the PLM 210 are adjustable MEMS reflectors which form a grid of pixels on the surface of the PLM 210. The heights of the micromirrors 215 with respect to the surface can be adjusted by applying voltages to the PLM 210. The first controller 242 controls the PLM 210 by changing the voltages applied to the PLM 210 to adjust the heights of the micromirrors 215 forming a certain hologram on the surface of the PLM 210. The hologram is a diffraction surface that is formed by providing different heights of the micromirrors 215 across the grid of pixels on the surface of the PLM 210. This diffraction surface modulates and reflects the incident light 250 from the one or more light sources 220 to project the modulated light 120.

The incident light 250 includes one or more color modes at respective wavelengths that are transmitted from the one or more light sources 220 to the PLM 210 through the focusing optics 230. The light sources 220 can be three light sources that provide three color modes at three respective wavelengths, such as for blue, green, and red light. The three color modes may provide three basic color components for displaying an image in full color. In examples, the light sources 220 can be three laser light sources that transmit the incident light 250 for three color modes at three respective wavelengths or ranges of wavelengths. The color modes can be projected by time multiplexing and in respective time durations that determine the color shades in the displayed image pixels. The focusing optics 230 can include one or more lenses that collimate and focus the incident light 250 onto the micromirrors 215. The spot of the incident light 250 on the micromirrors 215 can be focused to provide equal illumination across the grid of pixels for the different color modes.

The light sources 220 can be controlled by a controller 190 (e.g., the second controller 244), to project the incident light 250 for each color mode at a time to the PLM 210 with time multiplexing. Accordingly, each light source 220 is switched on at a time in a certain sequence and rate to project the incident light 250 for a respective color mode on the PLM 210. The rate can be within the HVS image integration rate to perceive the time multiplexed color modes in the displayed image as a single full color image. For example, the image projection rate can be between 30 frames per second and 60 frames per second.

The hologram or diffraction surface formed by the micromirrors 215 can also split the reflected incident light 250 into multiple light beams, also referred to herein as diffraction orders 265, that form the modulated light 120. In this example, the diffraction surface can include a structure of repeated surface patterns, also referred to herein as a diffraction grating, that is formed by the micromirrors 215. The surface patterns are repeated periodically in a direction across the surface which causes the splitting along the same direction the incident light 250 into the diffraction orders 265 in the modulated light 120. The repeated surface patterns of the diffraction surface alters the phases of the light waves that form the incident light 250 and reflects the light phases from the surface of the PLM 210 with different phases. The light waves having different phases are reflected by the diffraction surface in different directions which forms the diffraction orders 265. Accordingly, the diffraction orders 265 are reflected away from the surface of the PLM 210 at different reflection angles, also referred to herein as diffraction angles. The diffraction angles of the diffraction orders 265 depend on the incident angle of the incident light 250, the period of the repeated surface patterns of the diffraction surface, and the wavelength of the incident light 250. The diffraction orders 265 in the modulated light 120 may also have different intensities.

An image can be projected in a certain diffraction order 265 in the modulated light 120 on a far field image plane 270. In this example, the diffraction order 265 on which the image is projected has a higher intensity than other diffraction orders 265 in the modulated light 120. For example, the diffraction order 265 on which the image is projected may have more than 50% of the overall light intensity in the modulated light 120. In other examples, the same image can be projected by the PLM 210 simultaneously on multiple diffraction orders 265. In this example, multiple copies of the image can be projected on the far field image plane 270, where each copy of the image belongs to a respective diffraction order 265. The diffraction orders 265 can include a light beam in a center position between the diffraction orders 265, also referred to herein as a zero-order light. In examples, the image can be projected on the zero-order light. In other examples, the images can be projected on one or more diffraction orders 265 other than the zero-order light. In this example, the zero-order light can be useful to increase the illumination and accordingly brightness of the displayed images, or can be blocked from the far field image plane 270, such as to remove nonuniform illumination by the zero-order light in the displayed image. In examples, the images projected on multiple diffraction order 265 can be combined into a single displayed image by focusing optics (not shown) between the far field image plane 270 and a projection surface, such as the projection surface 130.

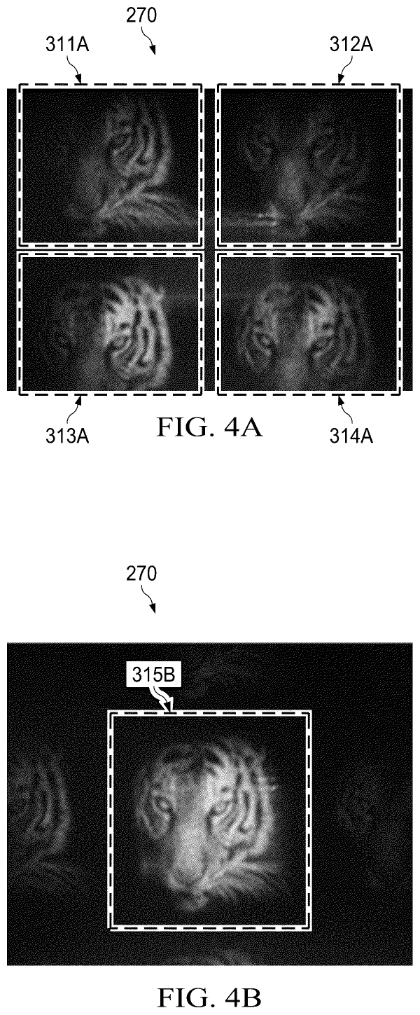

FIG. 3 shows a cross section view of the PLM 210 and the micromirrors 215 that project the diffraction orders 265 across a one-dimensional (1D) line in the far field image plane 270. FIG. 4A and FIG. 4B show projected images by the apparatus 209, in accordance with various examples. FIG. 4A is front view of the far field image plane 270 and shows four images 311A-314A of the same source image (e.g., image of a tiger head) that are projected across a two-dimensional (2D) plane on four respective diffraction orders 265, as shown in a front view of the far field image plane 270. In this example, no image is projected on the zero-order light. In FIG. 4B, an image 315B of the same source image is projected, as shown in the far field image plane 270, on the zero-order light in a center position between the diffraction orders 265.

In examples, the apparatus 209 in FIG. 3 may not include focusing optics to project the modulated light 120 from the PLM 210, such as onto the projection surface 130 of the display system 100. In this example, one of the images that is projected on a respective diffraction order 265 is displayed from the PLM 210 on the projection surface 130 which is located at or in front of the far field image plane 270. In examples, if the projection surface 130 is located farther away from the far field image plane 270, the image can be projected by projection optics (not shown) from the far field image plane 270 onto the projection surface 130. In other examples, multiple images projected on respective diffraction orders 265 can be focused and combined, by projecting and focusing optics (not shown), into a single image on the projection surface 130. In this example, the displayed image can have more uniform intensity and brightness across the image pixels in comparison to the images projected on the diffraction order 265. In examples, the apparatus 209 can also include optical elements (not shown), such as prisms, reflectors, or filters, to direct the incident light 250 in the optical path between the one or more light sources 220 and the PLM 210, or to direct the modulated light 120 between the PLM 210 and the far field image plane 270.

In other examples, the display device 110 may include an apparatus with multiple pairs of PLMs and respective light sources, each pair corresponding to a color mode provided from a respective light source. In this example, the PLMs can modulate simultaneously the respective color modes from the respective light sources. The multiple pairs of PLMs and light sources can increase the diffraction efficiency and the projected intensity of each color mode and accordingly increase image quality and power efficiency of the display device 110.

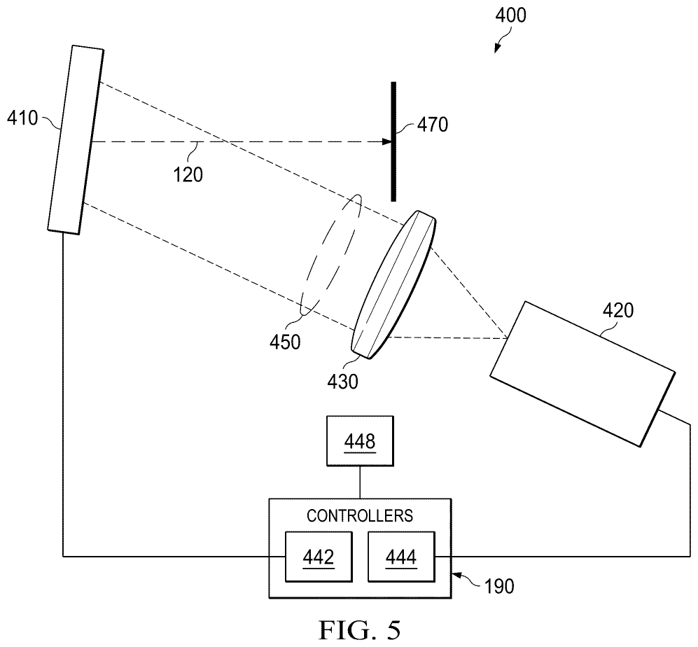

In other examples, a display system may include a liquid crystal-based display that projects a modulated light for displaying images. The liquid crystals in the device can have switching speeds within the same range as PLM micromirrors and can project images with equal time rates as PLMs, such as in kHZ. FIG. 5 is a diagram of an apparatus 400 including a liquid crystal device 410 for projecting images, in accordance with various examples. For example, the apparatus 400 can be the apparatus 150 of the display device 110 and is coupled to the one or more controllers 190. The apparatus 400 also includes one or more light sources 420 and focusing optics 430 located between and optically coupled to the liquid crystal device 410 and the one or more light sources 420. The focusing optics 430 can include a single projection lens, as shown in FIG. 5, or can include multiple lenses in other examples. The liquid crystal display device 410 and the one or more light sources 420 are coupled to and controlled by the one or more controllers 190.

In examples, as shown in FIG. 5, the one or more controllers 190 may include a first controller 442 for controlling the liquid crystal device 410 and a second controller 444 for controlling the one or more light sources 420. The controllers 190 may also include or may be coupled to a processor 448 configured to coordinate between the controllers 190 to control the liquid crystal device 410 and the one or more light sources 420 to modulate an incident light 450 transmitted from the one or more light sources 420. The liquid crystals in the liquid crystal device 410 can be arranged in an array of cells of liquid crystals with a reflective layer. The liquid crystals are configured to modulate and reflect the incident light 450 from the one or more light sources 420 generating the modulated light 120. The liquid crystals are controlled to modulate the intensity or the phase of the reflected light across the image pixels. The intensity or phase of light is modulated by applying voltages to the array of cells of liquid crystals that project the image pixels. For example, the voltages reorient the liquid crystals which adjusts the amount of light projected by the liquid crystals. In other examples, the liquid crystal device 410 can include an array of cells of transmissive liquid crystals and is located between and optically to the one or more light sources 420 and the projection surface 130.

The first controller 442 may be an analog controller that can control by voltage each of the cells of liquid crystals in the liquid crystal device 410. The amount of voltage can be controlled to change the level of light intensity and accordingly brightness in the image pixels. The liquid crystals are controlled to project an image on the modulated light 120 to a far field image plane 470. The far field image plane 470 can be located at, or projected (e.g., by projection optics) on, the projection surface 130. The second controller 444 can be a digital controller configured to switch the one or more light sources 420 on and off, or an analog controller that controls and changes the level of light intensity of the incident light 450 from the one or more light sources 420.

In examples, the liquid crystal device 410 can be a FLCoS device that includes FLCs. FLCs can be reoriented, also referred to herein as switched, by voltage at speeds that allows projecting the modulated light 120 and accordingly displaying images at a rate above 100 kHz. For example, FLCs can be switched within durations of less than 100 microsecond (μsec). The FLCoS device can include FLCs positioned between a glass layer and a pixelated reflective complementary metal-oxide-semiconductor (CMOS) chip. The CMOS chip includes an array of fixed micromirrors, such as aluminum micromirrors, and a circuit configured to receive video signals and convert the signals into digital voltages. The voltages are independently applied to each of the micromirrors switching a respective cell of FLCs which projects a pixel of the image. Depending on the voltage applied to each pixel, the FLCs are oriented in a certain respective direction, which modulates the polarization of the incident light 450 as reflected by the micromirrors generating the modulated light 120.

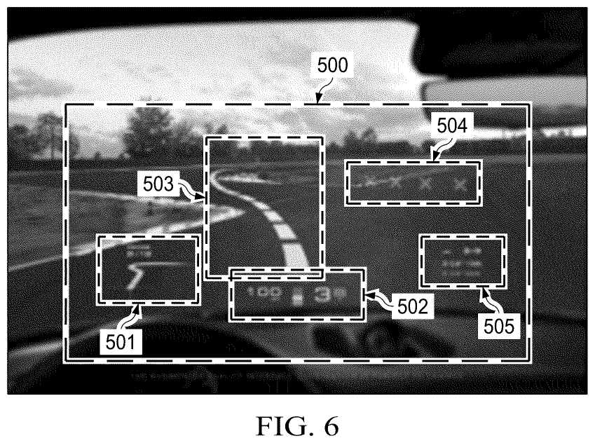

FIG. 6 shows an image 500 that can be displayed in a HUD system, such as the vehicle HUD system 200, by the apparatus 209 or 400, in accordance with various examples. The image 500 can be displayed on a windshield of a vehicle. As shown in FIG. 6, the image 500 is displayed on the windshield without blocking the view outside the windshield in front of the vehicle. For example, the HUD system can be the display system 100, where the windshield is the projection surface 130. The image 500 is displayed by projecting the modulated light 120 from the display device 110, which can be embedded in or mounted on the dashboard of the vehicle. The image 500 includes image components 501-505, which display data on the windshield with information useful to a driver or a front passenger. For example, the data can be displayed in the form of graphics, such as a dotted trajectory line in image component 503, or gauge markers (e.g., “x” shaped markers) in image component 504. The data displayed in the image 500 also includes a combination of text, level indicators, and/or graphics for displaying vehicle/route information as in image components 501, 502 and 505.

The image 500 displayed in the HUD system can include noise, which appears as random variation of brightness or color shades across the image 500. The noise can cause changes in the color shades of image pixels, such as in bright image pixels appearing darker and dark image pixels appearing brighter. The noise can reduce the quality of images displayed in the HUD system and accordingly reduce visibility to the viewer, such as to a driver through the windshield of the vehicle. The noise includes quantization noise caused by processing a digital source image to display the image 500. For example, the digital source image is processed to generate a PLM hologram by adjusting the micromirrors 215 of the PLM 210 in the apparatus 209 or to switch the FLCs of the liquid crystal device 410 in the apparatus 400. The amount of noise in the image 500 is also dependent on the image processing algorithm implemented to process the source image. The increase in noise increases the error in displayed brightness or color shades in the image pixels which reduces contrast across the image.

In examples, the apparatus 209 or the apparatus 400 can be controlled by the one or more controllers 190 to display images, such as in the HUD system, according to a time-sequential projection that increases contrast in the displayed images. To increase contrast in the displayed image, a source image, which can be stored in digital format, is processed by partitioning the source image into a plurality of digital sub-images. The sub-images can include respective and different image components of the source image. The sub-images are processed and projected in sequence in time to overlap on a surface, such as the projection surface 130. Each sub-image can have the same size (e.g., in pixels) as the source image and include a respective component of the source image and a remaining dark region. Each sub-image can be processed separately and projected in sequence in time at a rate allowing the HVS to integrate the overlapping sub-images into a single combined image that represents the source image. Because the sub-images include portions of the source image, the sub-images also include more dark pixels than the source image. Accordingly, the noise added to each projected sub-image can be localized to fewer bright pixels than the source image. The localization of the noise in the sub-images reduces noise across the single combined image perceived by the HVS, increasing the contrast in the image.

For example, the source image can be the image 500 in the case of a HUD system. The image 500 can be partitioned into five digital sub-images that include, respectively, the five image components 501 to 505 in the image 500. In this example, each digital sub-image generated from the image 500 can include one respective image component from the image components 501 to 505. In other examples, fewer than five sub-images can be generated from the image 500, where a sub-image can include more than one image component from the image components 501 to 505. Each of the digital sub-images has the same size of the image 500. The sub-images are then projected toward the windshield, such as by the PLM 210 or the liquid crystal device 410 on the modulated light 120, in sequence in time at a rate that allows the HVS to integrate the sub-images into the image 500. For example, the HVS image integration rate is supported by the switching speed for the micromirrors 215 of the PLM 210 or the FLCs of the liquid crystal device 410. Each digital sub-image is projected in a respective order in the time sequence.

In examples, a digital source image, such as of the image 500, can be processed to generate a PLM hologram in the apparatus 209 based on an iterative algorithm. The iterative algorithm is based on performing Fourier transforms over multiple iterations of calculation to update phase information for generating the hologram based on the source image. The phase information is updated at each iteration until a Fourier transform of the hologram based on the updated phase information of the source image is within a certain error threshold. The iterative algorithm can be based on the GS algorithm, also referred to herein as GS calculation method. The GS algorithm is an optimization algorithm where constraints, such as the desired source image in the far-field plane and phase-only representation in the PLM plane, are iteratively applied with the Fourier transform of the converged phase-only hologram to provide the desired source image.

The GS algorithm is initialized with a random phase pattern in the PLM plane. The Fourier transform of the phase pattern is computed to obtain the light distribution in the diffracted plane/far-field plane. The obtained amplitude in the far-field plane is then replaced with the desired amplitude of the source image. The phase in the in the far-field plane is left untouched. The updated far-field plane complex image is inverse Fourier transformed to the PLM plane and only the phase values are retained. The process with the source image amplitude constraint in the far-field plane and the phase-only constraint in the PLM plane is repeated over multiple iterations until the updated values of the source image and the hologram converge based on the error threshold. The GS algorithm is described in a paper titled, “A Practical Algorithm for the Determination of Phase from Image and Diffraction Pictures,” R. W. Gerchberg and W. O. Saxton, Cavendish Laboratory, Cambridge, United Kingdom (1971), which is hereby incorporated by reference herein in its entirety.

In other examples, the digital source image can be processed with other iterative algorithms or calculation methods based on performing Fourier transforms over multiple iterations to update the phase information for the hologram based on the source image. Such algorithms, including the GS algorithm, generate noise in the displayed image to represent the full complex value (e.g., with amplitude and phase) of a hologram by a phase-only hologram (e.g., with constant amplitude and random phase). Since the amplitude in the PLM plane is not modulated, the algorithm can introduce noise in the displayed image in the far-field plane. Further, noise may be added by the random phase values generated for the source image in the initial iteration. The noise may be distributed across the entire displayed image, such as in both the dark and bright regions of the displayed image. The presence of this noise, including the noise in the dark regions of the displayed image, reduces the image contrast. The noise can be expressed mathematically as a combination of the mean of the intensity in a region and the variance in the intensity of the region. If noise increases, the intensity variance increases in the displayed image. If noise decreases, the intensity variance decreases.

In the iterative algorithms, the noise may be related to the size and locations of the bright regions in the source image. For example, if the bright regions in the image are localized to an area of the image, the noise can also be localized to the same area and reduced in the remaining dark areas of the displayed image, resulting in higher contrast in such areas. If the source image is partitioned into multiple sub-images of the same size as the source image, where each sub-image includes one or some of the image components of the source image without the remaining image components, the sub-images can contain localized bright regions surrounded by remaining dark regions. In this example, by processing and projecting the sub-images separately, the noise in the displayed sub-images may be localized in and around the bright regions and is reduced in the remaining dark regions. If the sub-images are also projected in sequence in time within the HVS image integration rate, the source image can be displayed with higher contrast because the noise is localized to the bright regions and is reduced in the dark regions in the image.

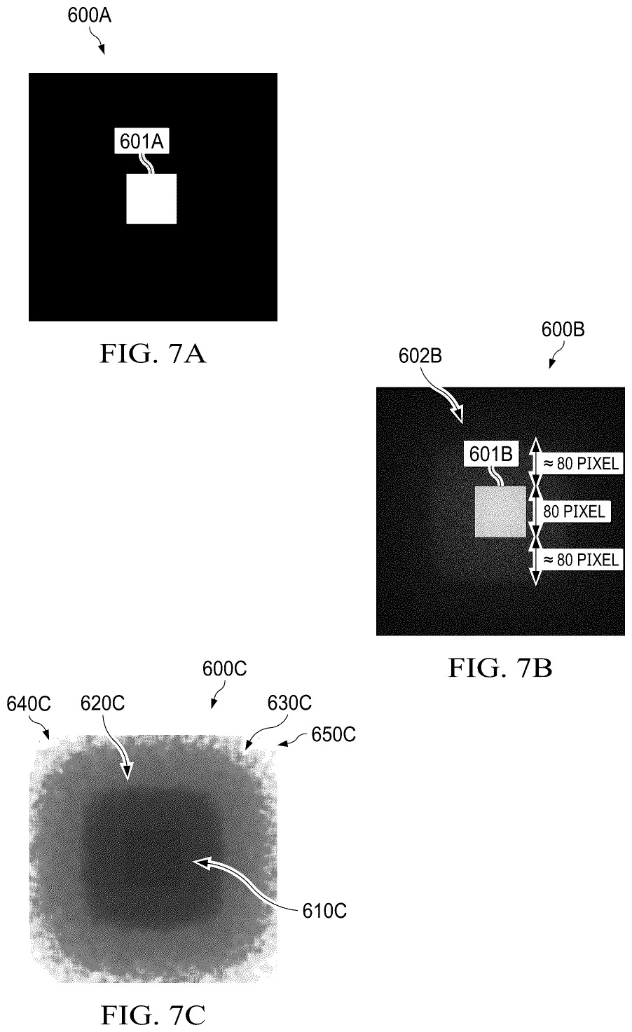

FIG. 7A shows a source image 600A with a single image component, in accordance with various examples. The source image 600A represents a digital image that can be processed by an iterative algorithm, such as the GS algorithm, to display a similar image by a projection-based display system, such as the display system 100. The image component is a square patch 601A representing a bright region surrounded by a dark region of the source image 600A. FIG. 7B shows a displayed image 600B that can be obtained by projecting the source image 600A, in accordance with various examples. The displayed image 600B is generated with calculations obtained by processing the source image 600A with the GS algorithm. The displayed image 600B includes a displayed square patch 601B in the bright region of the displayed image 600B surrounded by a dark region. The displayed square patch 601B has a width of 80 pixels. The displayed image 600B also includes noise 602B around the displayed square patch 601B. The noise extends within approximately 80 pixels on each side of the displayed square patch 601B. The noise 602B can appear to the HVS as gray pixels outside the displayed square patch 601B. As shown in FIG. 7B, the noise 602B is localized to the bright region of the displayed image 600B and decreases in the direction away from the bright region in the dark region around the bright region. For example, the noise 602B does not appear in the dark region at the edges of the displayed image 600B.

FIG. 7C is a diagram representing contrast variation 600C in the displayed image 600B, in accordance with various examples. The contrast variation 600C is obtained from the calculations in the GS algorithm. The contrast variation 600C represents contrast levels in multiple areas of the displayed image 600B. FIG. 7C shows five areas 610C-650C of various contrast levels in the displayed image 600B. The contrast levels increase in each area starting from a first area 610C in the bright region of the displayed square patch 601B, to a second area 620C around the bright region, and to the areas 630C, 640C and 650C that fall in the dark region of the displayed image 600B. The contrast levels are the highest in the area 650C at the edges of the displayed image 600B. FIG. 7C shows that the contrast is lower in and around the bright region of the image and is higher in the dark region away from a bright region. The contrast variation 600C shows an inverse relation with the noise 602B in the displayed image 600 that is higher in and around the bright region of the image and is lower in the dark region away from a bright region. FIG. 7C also shows that noise 602B which is localized to the bright region of the image component (the displayed square patch 601B) causes higher contrast in the dark region away from the image component.

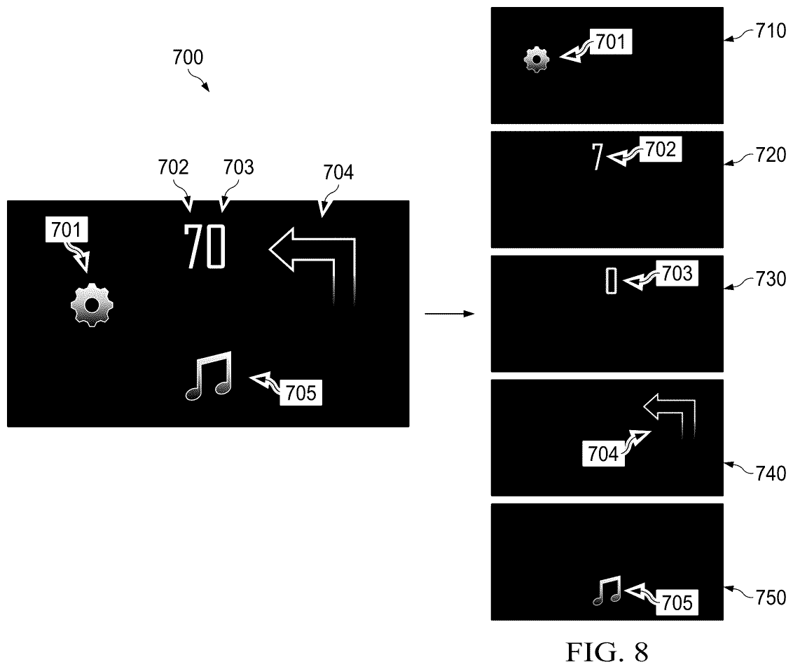

FIG. 8 shows a source image 700 including multiple image components 701-705, in accordance with various examples. The source image 700 can be a digital image processed by an iterative algorithm, such as the GS algorithm, to project the source image 700 for display by a projection-based display system, such as the display system 100. For example, the source image 700 can be processed to generate a PLM hologram in the apparatus 209 for a HUD system. The image components of the source image 700 include a first image component 701 that represents a knob, a second image component 702 that represents the number “7,” a third image component 703 that represents the number “0,” a fourth image component 704 that represent a left-turn arrow, and a fifth image component 705 that represents a music note. FIG. 8 also shows five digital sub-images 710-750 which can be obtained by partitioning the source image 700 into five images each including a respective image component from the image components 701-705. The sub-images include a first sub-image 710 with the first image component 701, a second sub-image 720 with the second image component 702, a third sub-image 730 with the third image component 703, a fourth sub-image 740 with the fourth image component 704, and a fifth sub-image 750 with the fifth image component 705. The digital sub-images 710-750 also have the same size as the source image 700, where the remaining area of the sub-images outside the respective image components include a dark region. For example, if the source image 700 is a rectangle shaped image with m×n pixels in size (where m and n are integer numbers), each of the sub-images 710 to 750 has the same m×n pixel size. The image components 701-705 also have the same pixel size in the source image and the respective sub-images 710-750.

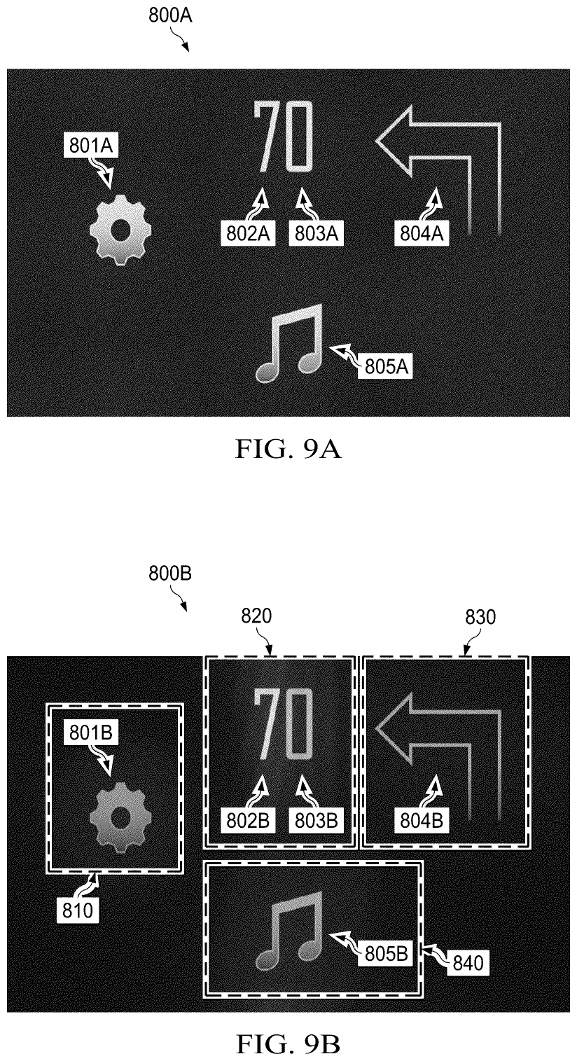

FIG. 9A shows a displayed image 800A that can be obtained by projecting the source image 700, in accordance with various examples. The displayed image 800A is generated with calculations obtained by processing the source image 700 with the GS algorithm. The displayed image 800A includes displayed image components 801A-805A which are the projections of the image components 701-705, respectively, of the source image 700. The displayed image 800A also includes noise that spreads across the displayed image 800A. The noise covers the displayed image components 701-705 and the remaining dark region of the displayed image 800A. As shown in FIG. 9A, the noise can appear to the HVS as gray pixels outside the displayed image components 801A-805A. This displayed noise reduces contrast across the image in the bright regions and the dark region.

FIG. 9B shows a displayed image 800B that can be obtained by projecting the sub-images 710-750 of the source image 700 according to a time-sequential projection, in accordance with various examples. The displayed image 800B is an integration of projections of the digital sub-images 710-750 as perceived by the HVS. For example, the digital sub-images 701-750 can be processed separately to generate respective PLM holograms in the apparatus 209 for projecting the sub-images 710-750. The projections of the digital sub-images 710-750 are obtained with calculations of the GS algorithm. The displayed image 800B is generated by overlapping the projections of the sub-images 710-750, and includes displayed image components 801B-805B which are the projections of the image components 701-705 in the combined sub-images 710-750, respectively. The displayed image 800B also includes noise that is localized in local areas that represent the bright regions of the displayed image 800B. The local areas include a first local area 810 containing a first displayed image components 801B, a second local area 820 containing a second displayed image component 802B and a third displayed image component 803B, a third local area 830 containing a fourth displayed image component 804B, and a fourth local area 840 containing a fifth displayed image component 805B.

As shown in FIG. 9B, the displayed image 800B does not include noise in the remaining dark region outside the local areas 810-840 of the bright regions in the displayed image 800B. This noise localization to the bright regions in the displayed image 800B is caused by processing each of the digital sub-images 710-750 separately with the GS algorithm. The localized noise increases contrast in the displayed image 800B. The contrast is increased in the dark region and where noise is lower around the bright areas of the displayed image components 801B-805B. The increase in contrast around the displayed image components 801B-805B increases image quality. In the case of a HUD system, the increase in contrast around the displayed image components 801B-805B and in the dark region of the displayed image 800B increases visibility, such as through a windshield of a vehicle. In other examples, the sub-images 710-750 can be processed by other iterative algorithms to generate respective PLM holograms in the apparatus 209 or to switch the FLCs in the apparatus 400.

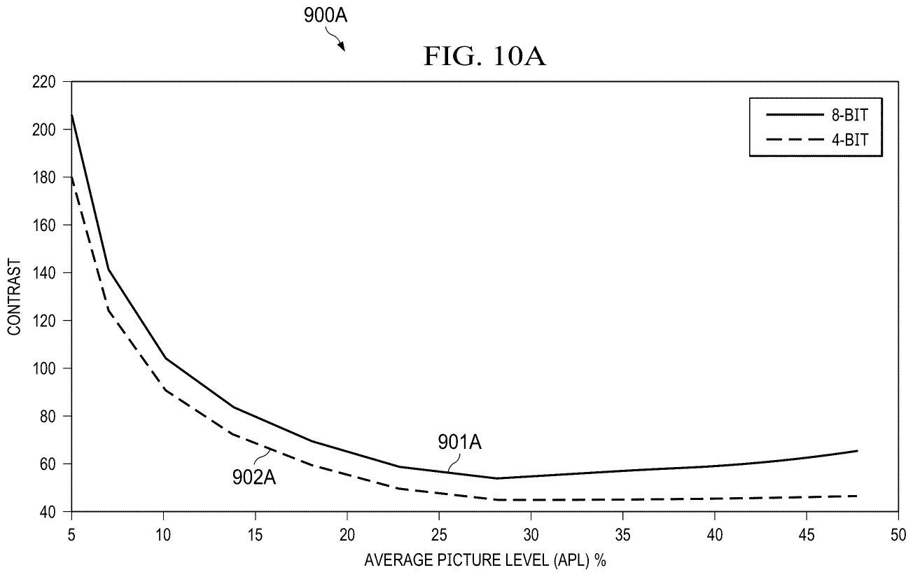

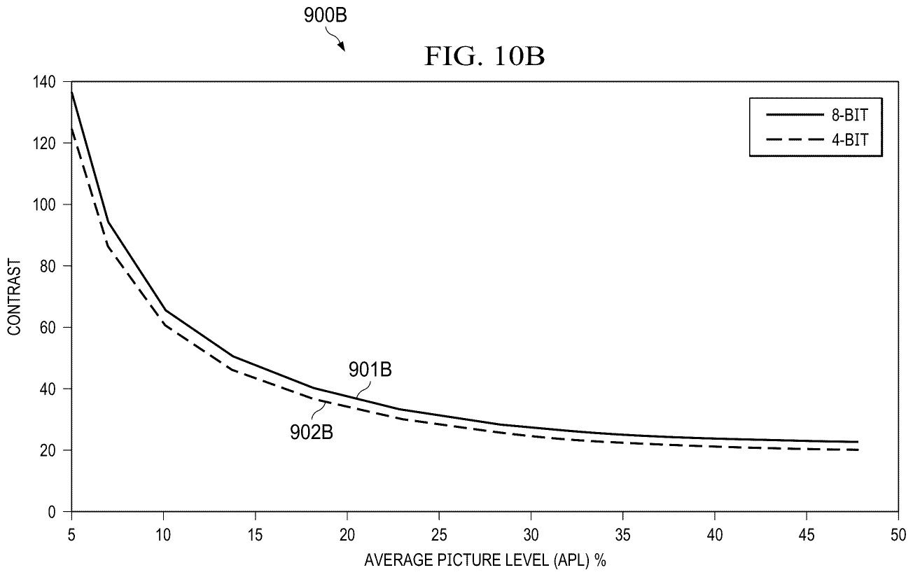

FIG. 10A and FIG. 10B are graphs representing contrast in displayed images that can be obtained by processing source images with different APLs, in accordance with various examples. The displayed images are generated with calculations obtained by processing the source images with the GS algorithm. The x-axis represents the APL in the source images and the y-axis represents the contrast level in the respective displayed images. The APL represents the brightness level in the source images. For example, an APL of 100% indicates an image containing all white pixels at maximum brightness, and an APL of 0% indicates an image containing all dark pixels with minimum brightness (e.g., black pixels with zero level of brightness).

FIG. 10A is a graph of contrast in the displayed images obtained by processing digital source images with fifty iterations of the GS algorithm. The contrast is represented by the curves 901A and 902A which include respective data points for the same group of source images. The curve 901A shows the contrast in displayed images obtained by processing the group of source images which are quantized with pixel values in 8 bits. The curve 902A shows the contrast in displayed images obtained by processing the same group of source images with pixel values in 4 bits. As indicated by the x-axis in FIG. 10A, the data points in the curves 901A and 902A are obtained for source images with APLs that increase from 5% to 50%. The source images with higher APLs include more image components with bright pixels. The increase in the APLs is caused by the increase in ratio of bright pixels in the image components to the dark pixels in the dark region.

The curves 901A and 902A indicate a decrease in the contrast of displayed images as the APL in the respective source images increases. This decrease in contrast can be caused by increase in noise in the GS algorithm, which is proportional to the APL. The curves 901A and 902A also show higher contrast in the case of source images with higher quantization. For example, a source image with an APL of 48% provides a displayed image with a contrast of approximately 65:1 if the source image is quantized with 8 bits and provides a displayed image with a contrast of approximately 40:1 if quantized with 4 bits. This increase in contrast can be caused by decrease in quantization noise in the GS algorithm.

FIG. 10B is a graph of contrast in the displayed images obtained by processing digital source images with five iterations of the GS algorithm. The contrast is represented by the curves 901B and 902B which include respective data points for the same group of source images. The data points in the curves 901B and 902B are obtained for source images which include different numbers of image components with APLs that increase from 5% to 50%. The curve 901B shows the contrast in displayed images obtained by processing the group of source images with pixel values in 8 bits. The curve 902B shows the contrast in displayed images obtained by processing the same group of source images with pixel values in 4 bits. For example, a source image with a quantization of 4 bits and an APL of 10% provides a contrast in the displayed image of approximately 60:1. Another source image also with a quantization of 4 bits and with an APL of 17% provides a contrast in the displayed image of approximately 85:1.

The data points in FIG. 10A and FIG. 10B show a loss of contrast due to reduced quantization in the source image. The loss in contrast because of quantization can be compensated by partitioning the image into sub-images with lower APLs and with the same quantization and projecting the sub-images according to a time-sequential projection within the HVS image integration rate. As shown in FIG. 10A and FIG. 10B, because the sub-images have lower APLs, the contrast in each projected sub-image can be higher than the contrast obtained by projecting the source image without partitioning. The single image perceived by the HVS as a combination of the sub-images can also have a contrast that is equal to the contrast in the sub-images. This increase in contrast can compensate for the loss in contrast that is caused by reducing the quantization of the source images (e.g., from 8 bits to 4 bits). The data points in FIGS. 10A and 9B also indicate that the sub-images can be processed with fewer iterations than the source image to project the respective displayed image. Accordingly, this time-sequential projection may not increase the processing time in comparison to projecting the source image without partitioning.

For example, if the quantization of the source image 700 in FIG. 8 is reduced from 8 bits to 4 bits and processed by the GS algorithm to project the displayed image 800A shown in FIG. 9A, the contrast in the image is reduced because of the increase in quantization noise. If the source image 700 is partitioned into the sub-images 710-750 (shown in FIG. 8) which are also processed in 4 bits to obtain the displayed image 800B shown in FIG. 9B, the APL in the displayed image 800B is reduced according to the APL in the sub-images 710-750 in comparison to the displayed image 800A. The reduced APL can increase the contrast in the displayed image 800B in comparison to the displayed image 800A. The increase in contrast based on reducing the APL can compensate for the quantization noise introduced in the processing of the sub-images 710-750.

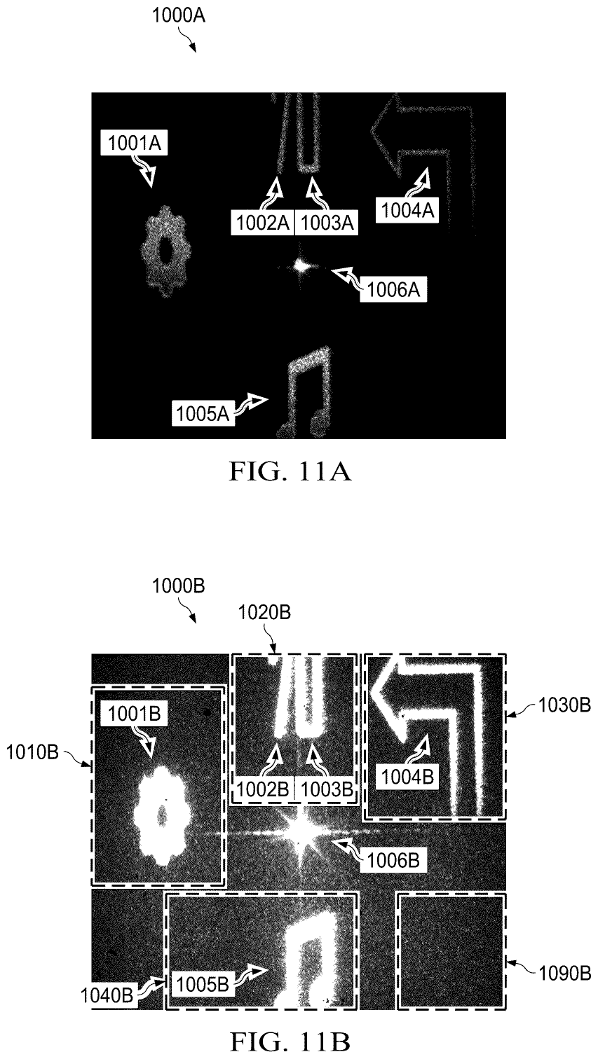

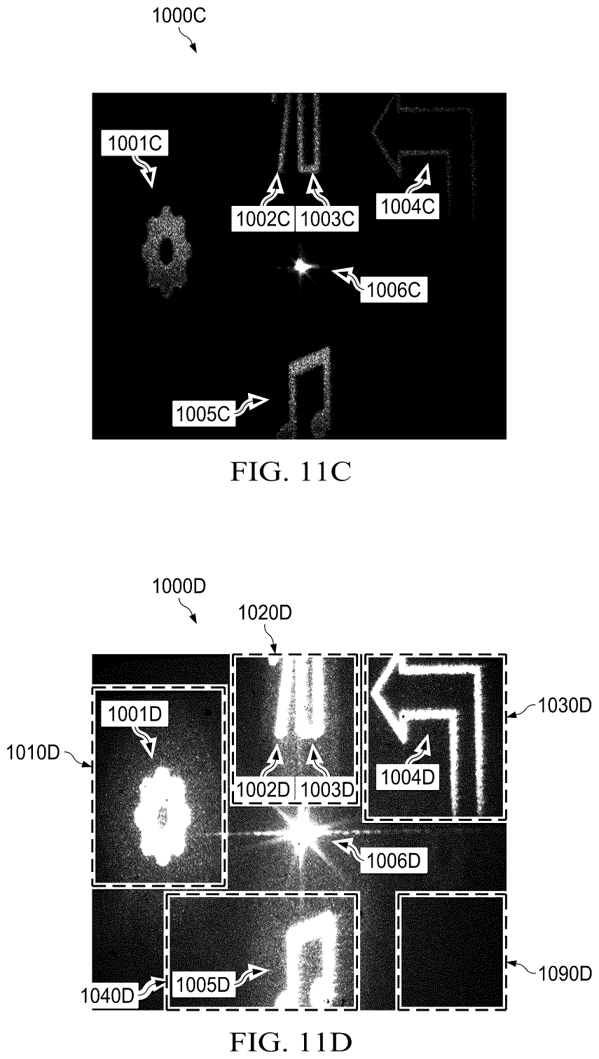

FIG. 11A shows a displayed image 1000A obtained by projecting the source image 700 with zero-order light illumination, in accordance with various examples. The displayed image 1000A is projected by processing the source image 700 with the GS algorithm. The displayed image 1000A includes displayed image components 1001A-1005A which are the projections of the image components 701-705, respectively, of the source image 700. The displayed image 1000A also includes a zero-order light spot 1006A obtained in a center position of the image as a projection of the zero-order illumination. The zero-order light illumination can be useful to increase illumination in the displayed image 1000A. The displayed image 1000A also includes noise that spreads across the displayed image 1000A in the bright regions of the displayed image components 1001A-1005A and the remaining dark region.

FIG. 11B shows a displayed image 1000B obtained by projecting the source image 700 with zero-order light illumination and with high gain light intensity, in accordance with various examples. The displayed image 1000B is obtained by processing the source image 700 similar to the displayed image 1000A. The displayed image 1000B is also projected with higher intensity of illumination in comparison to the displayed image 1000A to provide the high gain light intensity. The intensity of illumination in the displayed image 1000B is equal to approximately 2.25 times the intensity illumination in the displayed image 1000A. The high gain light intensity in the displayed image 1000B causes the displayed image components 1001B-1005B, which are the projections of the image components 701-705, to appear brighter in comparison to the displayed image components 1001A-1005A, respectively, in the displayed image 1000A. The zero-order light spot 1006B which is the projection of the zero-order illumination in the displayed image 1000B also appears brighter than the zero-order light spot 1006A in the displayed image 1000A.

The high gain light intensity in the displayed image 1000B also increases the noise in comparison to the displayed image 1000A. The noise can be quantified by the mean average of light intensity across the image and can increase if the illumination in the image is increased. This causes the noise to be more visible in the displayed image 1000B and appears as gray pixels outside the displayed image components 1001B-1005B. The higher noise also causes lower contrast in the displayed image 1000B than the displayed image 1000A.

FIG. 11C shows a displayed image 1000C obtained by projecting the sub-images 710-750 of the source image 700 according to the time-sequential projection and with zero-order light illumination, in accordance with various examples. The projections of the digital sub-images 710-750 are obtained based on the GS algorithm. The displayed image 1000C is the overlap of the projections of the sub-images 710-750 as perceived by the HVS, and includes displayed image components 1001C-1005C which are the projections of the image components 701-705, respectively. The displayed image 1000C also includes a zero-order light spot 1006C obtained in a center position of the image as a projection of the zero-order illumination. The displayed image 1000C also includes noise which may be localized to the bright regions of the displayed image components 1001C-1005C. The noise can reduce contrast across the displayed image 1000C in comparison to the displayed image 1000A. The noise which is proportional to the light intensity in the image and can increase if the illumination in the image is increased.

FIG. 11D shows a displayed image 1000D obtained by projecting the sub-images 710-750 of the source image 700 according to a time-sequential projection with zero-order light illumination and high gain light intensity, in accordance with various examples. The displayed image 1000D is obtained by processing the source image 700 similar to the displayed image 1000C. The displayed image 1000D is projected with higher intensity of illumination in comparison to the displayed image 1000C to provide the high gain light intensity. The intensity of illumination in the displayed image 1000D is equal to approximately 2.25 times the intensity illumination in the displayed image 1000C. The high gain light intensity in the displayed image 1000D causes the displayed image components 1001D-1005D, which are the projections of the image components 701-705, to appear brighter in comparison to the displayed image components 1001C-1005C, respectively, in the displayed image 1000C. The zero-order light spot 1006D which is the projection of the zero-order illumination in the displayed image 1000D also appears brighter than the zero-order light spot 1006C in the displayed image 1000C.

The high gain light intensity in the displayed image 1000D also causes the noise to increase and appear more visible in comparison to the displayed image 1000C. The noise appears in the displayed image 1000D as gray pixels outside the displayed image components 1001D-1005D. As shown in FIG. 11D, the noise is localized in local areas 1010D-1040D that contain the displayed image components 1001D-1005D. In comparison, the noise in the displayed image 1000B is not limited to the local areas 1010B-1040B that contain the displayed image components 1001B-1005B. The noise in the displayed image 1000B also spreads outside the local areas 1010B-1040B in the dark region of the displayed image 1000B. Accordingly, the noise decreases and contrast increases in the displayed image 1000D in comparison to the displayed image 1000B. Because the sub-images 710-750 have lower APL than the source image 700, the quantization noise in the GS algorithm can decrease and the contrast in the displayed image 1000D increases in comparison to the displayed image 1000B.

For example, the intensity mean in the corner area 1090B of the displayed image 1000B is equal to 29.7 on a scale of gray values and the intensity mean in the corner area 1090D of the displayed image 1000D is equal to 13.24 measured units. The scale of gray values represents the brightness of pixels in the image and ranges from 0 to 255, with 0 representing a full dark pixel and 255 representing a saturated bright pixel. The reduced mean intensity in the corner area 1090D of the displayed image 1000D represents lower noise and higher contrast in comparison to the corner area 1090B of the of the displayed image 1000B. Visible noise in the corners of a displayed image is also referred to herein as the postcard effect. The post card effect can be reduced or cancelled by the time-sequential projection of sub-images with lower APL and within the HVS image integration rate. This projection method is useful for displaying images with few image components (e.g., within five or ten components) that are separated by dark pixels or regions. For example, the time-sequential projection method is useful in an AR HUD system where images with few image components are displayed and the postcard effect is mitigated to improve visibility.

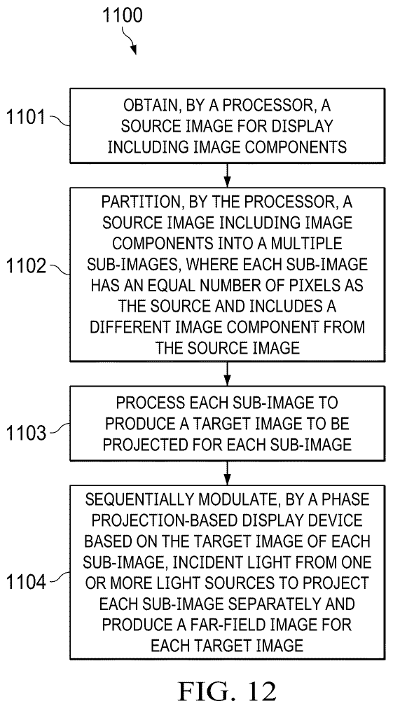

FIG. 12 is a flow diagram of a method 1100 for time-sequential projection of sub-images to display a source image, in accordance with various examples. For example, the steps of the method 1100 can be implemented by the display device 110, the apparatus 209, or the apparatus 400. The method 1100 is implemented to project and display images in a projection-based display system, such as the display system 100. In examples, the display system is a HUD system of a vehicle or a wearable AR HUD device, such as AR glasses.

At step 1101, a source image including one or more image components is obtained, by a processor, for display. At step 1102, the source image including image components is partitioned by the processor into multiple sub-images with the same pixel size as the source image. Accordingly, each sub-image from the sub-images includes a corresponding image component of the image components in the source image. In examples, the image components in the source image can be detected with an image recognition algorithm or processing method for identifying objects in an image. Examples of image recognition algorithms or processing methods can include machine learning by neural networks, training and test data/models, or other object detection and image recognition methods. The image components can also be detected with metadata provided or included in the source image. For example, the source image can be generated with image components and metadata indicating information about the image components. The metadata can be included in a same file of the source image or in a metadata file processed with the source image. The metadata can include information such as size, color, and location of the image components in the image. After detecting the image components, each image component can be separately included in a respective sub-image, where the remaining area in the sub-image can be empty of objects and represented by black pixels. The image component can have the same location in the respective sub-image as the source image. In examples, multiple image components from the source image can be included in the same respective sub-image if the image components are detected within a certain threshold distance in the source image, such as relative to other image components or the image size.

Each sub-image has an equal number of pixels as the source image and includes a different image component from the source image. Because each sub-image include one or fewer image components of the source image, each sub-image also has an APL lower than the source image. The number of sub-images of the source image is determined based on the number of image components in the source image. In the case where each sub-image includes only one image component of the source image, the number of the sub-images is equal to the number of image components in the source image. The source image can be stored in digital format in memory in the form of pixel values in bits, which represent the color shades across the source image. The digital source image is partitioned by a processor into sub-images that have the same number of pixels and a different image component of the source image. The source image may include few image components (e.g., fewer than ten image components) that display data (e.g., text, graphics, etc.) and that are separated by dark pixels or regions in the source image. For example, the source image 700 can be partitioned into the sub-images 710-750 by the processor 248 in the apparatus 209 or the processor 448 in the apparatus 400. The sub-images 710-750 include the respective image components 701-705.

At step 1103, each sub-image is processed, by the processor, to produce a target image to be projected for each sub-image. For example, the sub-images can be processed separately according to an iterative algorithm, such as the GS algorithm, to calculate respective holograms for projecting the sub-images. For each sub-image, the hologram is obtained by the algorithm based on a Fourier transform relationship between the hologram and the respective target image, which represents the far-field image. For example, the sub-images 710-750 are each processed by the GS algorithm to generate a respective hologram for the PLM 210 in the apparatus 209. The values of the processed sub-images can be sent as voltage values to control the micromirrors 215 of the PLM 210 (e.g., by the first controller 242). In examples, the sub-images can be processed by algorithms other than the GS algorithm, which may or may not be iterative algorithms, to generate the respective holograms for projecting the sub-images. The sub-images can also be processed by the same or other algorithms, such as for switching liquid crystals in liquid crystal devices, to project the sub-images separately.

At step 1104, incident light from one or more light sources is sequentially modulated by a phase projection-based display device based on the target image of each sub-image to project each sub-image separately and produce a far-field image for each target image. The sub-images of the source image can be projected in sequence in time at a certain rate within the HVS image integration rate for perceiving the projected sub-images as a single image representing the source image.

For example, the phase projection-based display device can be the PLM 210 in the apparatus 209. For each processed sub-image of the sub-images 710-750, the PLM 210 modulates separately the incident light 250 by a respective hologram formed by the micromirrors 215 according to the voltage values of the respective sub-image. Accordingly, the PLM 210 projects each sub-image in sequence in time on the modulated light 120 at a rate within the HVS image integration rate. This allows the HVS to integrate the overlapping sub-images (e.g., displayed on the projection surface 130) into a single displayed image 800B that represents the source image 700. The sub-images 710-750 can be projected by the PLM 210 on one or more diffraction orders 265 in the modulated light 120, which may include the zero-order light.

In other examples, the liquid crystal device 410 modulates the incident light 450 by switching the FLCs according to the voltage values of each processed sub-image of the sub-images 710-750 separately. Accordingly, the liquid crystal device 410 projects each sub-image in sequence in time on the modulated light 120 at a rate within the HVS image integration rate. The phase projection-based display device can be a FLCoS device including FLCs. The FLCs can be switched by voltage to electrically adjust the optical refractive index across the surface and accordingly produce a phase altering reflective surface that represents a phase hologram. The sub-images can be processed separately according to iterative algorithms, such as the GS algorithm, or other algorithms to obtain the respective phase holograms on the FLCoS to project the sub-images.

The method 1100 can reduce noise and increase contrast in the projected sub-images in comparison to projecting the source image without partitioning and higher APL. The increase in contrast can allow reducing the quantization of the pixel values (e.g., in bits) in the processing of the sub-images. Reducing the quantization can reduce processing time and power cost in the system. For example, if the pixel values of the source image 700 are stored in 8-bit values, the pixel values can be approximated by 4-bit values. The source image 700 is hence partitioned in to the sub-images 710-750 with 4-bit pixel values.

The term “couple” is used throughout the specification. The term may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A system or device that is described herein as including certain components may instead be adapted to be coupled to those components to form the described structure, device, or apparatus. For example, an apparatus described as including one or more devices (such as PLMs, FLCs or light sources), one or more optical elements (such as lenses), and/or one or more electronic components (such as controllers, processors, or memories) may instead have at least some of the components integrated into a single component which is adapted to be coupled to the remaining components either at a time of manufacture or after a time of manufacture, for example, by an end-user and/or a third-party.

While certain components may be described herein as being of a particular process technology, these components may be exchanged for components of other process technologies. Devices described herein are reconfigurable to include the replaced components to provide functionality at least partially similar to functionality available prior to the component replacement.

Unless otherwise stated, “about,” “approximately,” or “substantially” preceding a value means+/−10 percent of the stated value. Modifications are possible in the described examples, and other examples are possible within the scope of the claims.

What is claimed is:

1. A device, comprising:
at least one processor configured to:
partition a source image including image components into sub-images, the sub-images each including a corresponding image component of the image components; and
process each sub-image to produce a target image to be projected for each sub-image of the sub-images;
one or more light sources coupled to the at least one processor, the one or more light sources configured to project an incident light; and
a phase projection-based display device coupled to the at least one processor and optically coupled to the one or more light sources, the phase projection-based display device configured to modulate, based on the target image of each sub-image, the incident light to separately project the sub-images.

2. The device of claim 1, wherein each sub-image includes a different image component of the image components from the source image, and wherein each sub-image of the sub-images includes a number of pixels equal to the source image.

3. The device of claim 1, wherein the phase projection-based display device is a phase light modulator (PLM).

4. The device of claim 3, wherein the PLM includes micromirrors configured to form a respective hologram for projecting each sub-image and split the incident light into multiple diffraction orders in the modulated incident light, wherein each sub-mage is projected on one or more diffractions orders.

5. The device of claim 4, wherein the modulated incident light includes a zero-order light projected with the sub-images.

6. The device of claim 1, wherein the phase projection-based display device is a ferroelectric liquid crystal on silicon (FLCoS) device.

7. The device of claim 1, wherein the sub-images have lower average picture levels (APLs) than the source image.

8. The device of claim 7, wherein the source image includes fewer than ten image components that are separated by dark pixels or a dark region in the source image.

9. The device of claim 1, wherein the image components include data represented by text and/or graphics.

10. The device of claim 1, further comprising focusing optics optically coupled to the one or more light sources and the phase projection-based display device.

11. The device of claim 1, wherein a first number of the sub-images is based on a second number of the image components in the source image.

12. A vehicle comprising:
a projector device mounted in the vehicle, the projector device comprising:
at least one processor configured to:
partition a source image including image components into multiple sub-images, the sub-images each including a corresponding mage component of the image components; and
process each sub-image to produce a target image to be projected for each sub-image;
one or more light sources coupled to the at least one processor, the one or more light sources configured to project an incident light; and
a phase projection-based display device coupled to the at least one processor and optically coupled to the one or more light sources, the phase projection-based display device configured to modulate, based on the target image of each sub-image, the incident light to separately project the sub-images,
wherein the phase projection-based display device is configured to project the sub-images on a projection surface on a front windshield of the vehicle.

13. The vehicle of claim 12, wherein the image components in the sub-images indicate information, and wherein the information include a road trajectory line, route information or conditions, vehicle information or conditions, messages, or alerts.

14. The vehicle of claim 12, wherein the projector device is mounted on or coupled to a dashboard, the front windshield, or an interior roof of the vehicle, wherein the projector device and the projection surface are facing a driver seat or at a center front position of the vehicle.

15. The vehicle of claim 12, wherein the projection surface comprises a holographic optical element (HOE), and wherein the phase projection-based display device is configured to project the sub-images onto the HOE.

16. A method comprising:
obtaining, by a processor, a source image including image components;
partitioning, by the processor, the source image including image components into multiple sub-images, wherein each sub-image of the sub-images has a same size as the source image, and wherein each sub-image includes a different image component of the image components from the source image;
processing each sub-image to produce a target image to be projected for each sub-image; and
sequentially modulating, by a phase projection-based display device and based on the target image of each sub-image, incident light from one or more light sources to project each sub-image separately and produce a far-field image for each target image.

17. The method of claim 16, wherein the phase projection-based display device includes a phase light modulator (PLM), and wherein each sub-image is processed to generate a respective hologram on the PLM for modulating the incident light.

18. The method of claim 17, wherein each sub-image is processed over multiple iterations based on a Gerchberg and Saxton (GS) calculation method, and wherein the sub-image is processed and projected with fewer iterations of the GS calculation method in comparison to processing and projecting the source image.

19. The method of claim 16, wherein the phase projection-based display device includes a ferroelectric liquid crystal on silicon (FLCoS), and wherein each sub-image is processed to modulating a polarization of the incident light to project the target image.

20. The method of claim 16, further comprising detecting the image components in the source image based on an image recognition method for identifying objects in the source image or based on metadata including information about the image components in the source image.
